(19) United States
(12) Patent Application Publication
(10) Pub. No.: US 2005/0070284 A1
(43) Pub. Date: Mar. 31, 2005

(54) Method for mobile device communications

(76) Inventor: Steven D. Cheng, San Diego, CA (US)

Correspondence Address: SNELL & WILMER;ONE ARIZONA CENTER, 400 EAST VAN BUREN, PHOENIX, AZ, 850040001, US

(21) Appl. No.: 10/672,387

(22) Filed: Sep. 26, 2003

(51) Int. Cl. H04Q 7/20

(52) U.S. Cl. 455/435.3; 455/437; 455/411

(57) ABSTRACT

A method for proceeding with communications by a mobile device is provided. The method first determines if any registered public land mobile network has been stored in the mobile device. If yes, the method determines if the signals from the registered public land mobile network are clear enough to maintain a good communication quality. If yes, the method determines if the mobile device is one legitimate user of the registered public land mobile network. If yes, the mobile device starts to transmit signals via the registered public land mobile network.

### FIELD OF INVENTION

The present invention relates to a communication method and, more particularly, relates to an emergency communication method used with a mobile device.

### BACKGROUND OF THE INVENTION

In addition to regular communications, personal mobile devices also can provide a call-for-help service when an emergency situation occurs. However, mobile devices need a period of time to connect to a wireless communication system at the beginning and, moreover, need even more time to search for an available base station if the users are located in a disturbed environment. This searching time does not cause problems to the users under regular circumstances, but it may result in a serious consequence in emergencies.

To overcome this problem, the method of the prior art is shown in FIG. 1. In step 100, a mobile device is switched on to initialize. In step 102, the mobile device detects if any information of a registered public land mobile network (RPLMN) is stored within the device. The RPLMN is the network which the mobile device has registered to use. It is noted that a mobile device may have several RPLMNs. If there are several RPLMNs stored in the mobile device, one of them is selected in step 104. In step 106, the selected RPLMN determines whether the mobile device is a legitimate user of itself. If yes, a base station is selected in step 108 and then the user can communicate through the selected RPLMN and the base station.

If there is no RPLMN found stored in the mobile device in step 102, or the mobile device is determined not a legitimate user of the selected RPLMN in step 106, then the method of the prior art selects one public land mobile network (PLMN) from a public land mobile network list stored in the mobile device for communication in step 110, wherein the public land mobile network list records all public land mobile networks. In step 112, the selected PLMN (first PLMN) determines whether the mobile device is a legitimate user of itself. If yes, the method executes step 108, selecting a base station and enabling the user to communicate through the first PLMN. If not, the mobile device searches for another available PLMN (second PLMN) in step 114 and then the second PLMN determines whether the mobile device is a legitimate user of itself in step 116. If yes, the method executes step 108, selecting a base station and enabling the user to communicate through the second PLMN. Otherwise, the method returns to step 114 to search for another PLMN (third PLMN).

There are many sub-steps to be executed in step 108. As FIG. 2 shows, the mobile device first determines whether a base station list is stored within the device, wherein the base station list records the information of the base stations which have been used before. If yes, one appropriate base station is selected from the base station list in step 202. In step 204, the mobile device communicates via the base station. If no base station list is found in the mobile device in step 200, step 206 is executed so that the mobile device starts to search for available base stations. Then the method returns to step 202 in which the mobile device can select an appropriate base station according to the searching result.

In addition to the above sub-steps, the mobile device would determine whether re-selecting a base station is needed in every particular time frame during the communication (step 208). This can avoid sudden disconnection caused by reduction of signal strength. If the mobile device needs to re-select a base station, the method returns to step 206 to search for available base stations to maintain communication quality. However, if the signal strength is still strong, the mobile device would continue communicating without switching to another base station.

One defect of the prior art is that even though the mobile device has selected a RPLMN in step 104, disconnection still could happen as the signal strength transmitted from the RPLMN becomes weak. Moreover, if it is determined that re-selecting a base station is needed in step 208, the mobile device takes some time to re-select a base station and this extra searching time would not be allowed for an emergency call.

### SUMMARY OF THE INVENTION

The present invention provides a method for communicating with a mobile device, especially for emergency communicating. The method includes the step of determining if there is an RPLMN information stored in the mobile device. If yes, the mobile device subsequently determines whether the signal strength transmitted from the RPLMN is larger than a predetermined level to ensure that the signal strength is able to support a minimum required quality. If yes, the RPLMN farther determines whether the mobile device is a legitimate user of itself. If yes, the mobile device selects a base station and uses the RPLMN to communicate.

To select a base station, the method of the present invention first determines whether the mobile device has a base station list. If not, the mobile device searches for all of the available base stations and stores them in a base station list. Once the mobile device detects that signal strength is reducing during communicating, it can immediately find another available base station without searching again. This would avoid disconnection, especially in emergency cases.

### BRIEF DESCRIPTION OF THE DRAWINGS

FIG. 1 illustrates the method of the prior art for selecting a PLMN;

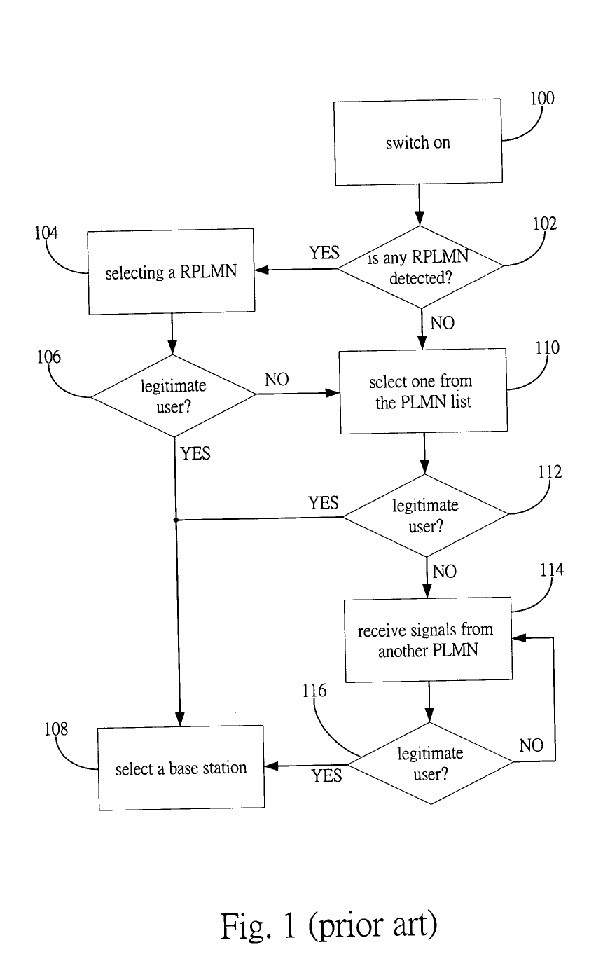

FIG. 2 illustrates the method of the prior art for selecting a base station;

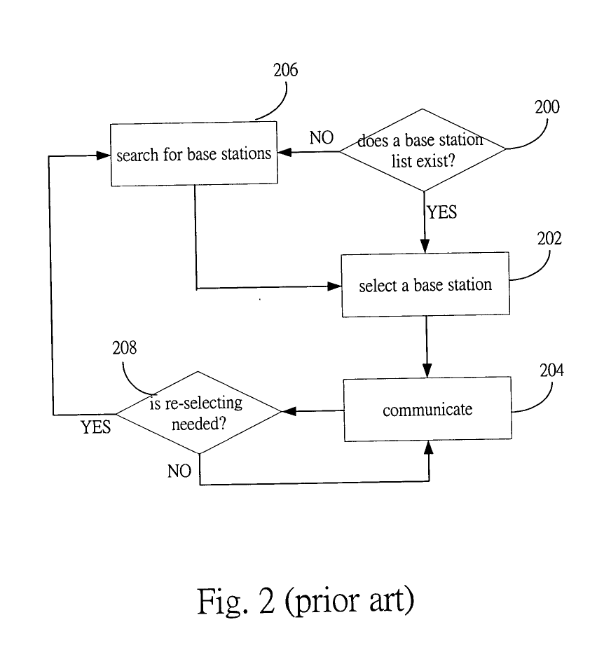

FIG. 3 illustrates the method of the present invention for selecting a PLMN; and

FIG. 4 illustrates the method of the present invention for selecting a base station.

### DETAILED DESCRIPTION

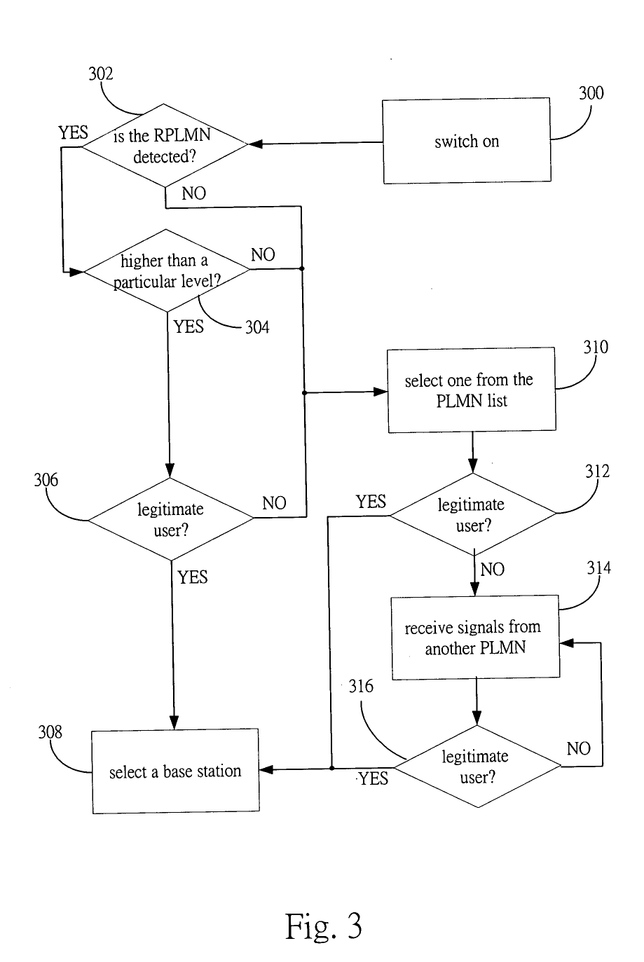

The present invention provides a method for communicating with a mobile device, especially for emergency communicating. The mobile device includes an RPLMN and a PLMN list. As FIG. 3 shows, the mobile device is switched on to initialize in step 300. In step 302, the mobile device determines whether the RPLMN is detected. If yes, the mobile device determines whether the signal strength transmitted from the RPLMN is larger than a particular level in step 304. The particular level is used to ascertain if the signal strength of the RPLMN is strong enough to maintain the communication quality. The present invention does not limit the setup way and value of this particular level. If the signal is above the particular level, the RPLMN determines whether the mobile device is a legitimate user of itself in step 306. If yes, the mobile device selects a base station to communicate in step 308.

If the mobile device determines that no RPLMN exists in step 302, if the mobile device determines that the signal strength is not larger than the particular level in step 304, or if the mobile device is not a legitimate user of the RPLMN in step 306, then the mobile device selects a first PLMN from the PLMN list. In step 312, the first PLMN determines whether the mobile device is a legitimate user of itself, especially in an emergency situation. If yes, the method of the present invention skips to step 308 to select a base station to communicate.

If the mobile device is determined not a legitimate user of the first PLMN in step 312, the method of the present invention executes step 314 to search for a second PLMN. In step 316, the second PLMN determines whether the mobile device is a legitimate user of itself If not, the method of the present invention returns to step 314 to search for another PLMN (third PLMN). If yes, the mobile device selects a base station to communicate in step 308.

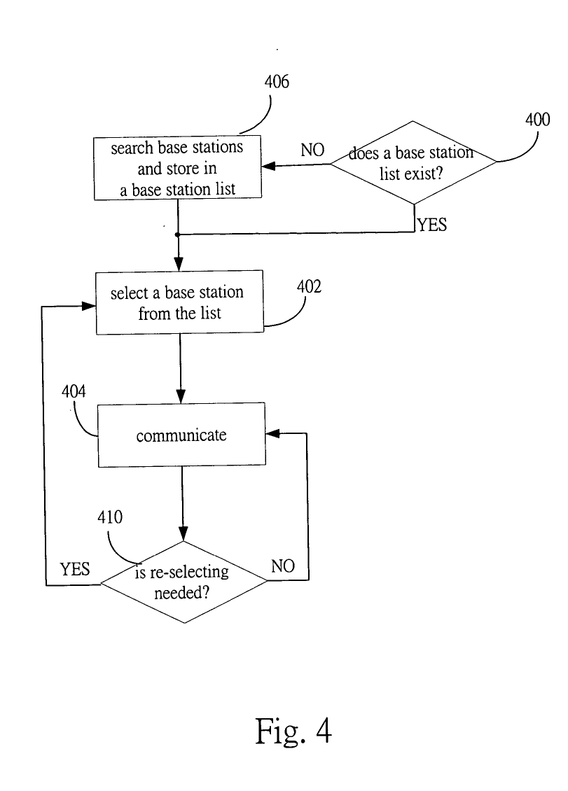

There are many sub-steps in step 308. As FIG. 4 shows, the mobile device determines if any base station list is stored in itself in step 400. The list records the information of the base stations which have been used before. If yes, step 402 is executed to select a base station from the list. In step 404, the mobile device communicates via the selected base station.

If the mobile device determines that there is no base station list in step 400, the method of the present invention goes to step 406 to search for a plurality of available base stations and stores corresponding information in a base station list. The mobile device then executes step 402 to select a base station from the base station list and proceeds with communicating via the selected base station in step 404.

Because of the environment or other factors, the signals transmitted from the selected base station might become too weak to maintain communication quality. Therefore, in step 410, the mobile device detects the strength of the signals transmitted from the base station to determine whether re-selecting a base station is needed in a particular time frame. If yes, the method returns to step 402 to select another available base station from the base station list. If not, the method returns to step 404 to continue communicating.

The mobile device mentioned above might be a mobile phone.

The above description of the preferred embodiments is expected to clearly expound the characteristics of the present invention but not expected to restrict the scope of the present invention. Those skilled in the art will readily observe that numerous modifications and alterations of the apparatus may be made while retaining the teaching of the invention. Accordingly, the above disclosure should be construed as limited only by the bounds of the claims.

1. A method for communicating with a mobile device, the mobile device comprising a registered public land mobile network (RPLMN) and a public land mobile network list, the method comprising the steps of:
(a) determining if the RPLMN is detected, if not, executing the step (d);
(b) determining if a signal strength transmitted from the RPLMN is higher than a particular level, if not, executing the step (d);
(c) determining if the mobile device is a legitimate user of the RPLMN, if yes, executing the step (h), if not, executing the step (d);
(d) selecting a first public land mobile network (PLMN) from the public land mobile network list;
(e) determining if the mobile device is a legitimate user of the first PLMN, if yes, executing the step (h);
(f) receiving a signal of a second PLMN;
(g) determining if the mobile device is a legitimate user of the second PLMN, if not, executing the step (f); and
(h) selecting a base station to communicate.

2. The method of claim 1, wherein the step (h) comprises:
(i) determining if the mobile device comprises a base station list, if yes, executing the step (k), if not, executing the step (j);
(j) searching for a plurality of available base stations and storing in a base station list;
(k) selecting a base station from the base station list; and
(l) communicating via the base station.

3. The method of claim 2, wherein the step (1) comprises:
(m) determining if re-selecting a base station is needed in a particular time interval, if yes, executing the step (k).

4. The method of claim 1, wherein the mobile device is a mobile phone.

5. A method for communicating with a mobile device, the mobile device comprising a registered public land mobile network (RPLMN) and a public land mobile network list, the method comprising the steps of:
(a) determining if the RPLMN is detected, if not, executing the step (d);
(b) determining if a signal strength transmitted from the RPLMN is higher than a particular level, if not, executing the step (d);
(c) determining if the mobile device is a legitimate user of the RPLMN, if yes, executing the step (h), if not, executing the step (d);
(d) selecting a first public land mobile network (PLMN) from the public land mobile network list;
(e) determining if the mobile device is a legitimate user of the first PLMN, if yes, executing the step (h);
(f) receiving a signal of a second PLMN;
(g) determining if the mobile device is a legitimate user of the second PLMN, if not, executing the step (f);
(h) determining if the mobile device comprises a base station list, if yes, executing the step (j), if not, executing the step (i);
(i) searching for a plurality of available base stations and storing in a base station list;
(j) selecting a base station from the base station list; and
(k) communicating via the base station.

6. The method of claim 5, wherein the step (k) comprises:
(l) determining if re-selecting a base station is needed in a particular time interval, if yes, executing the step (j).

7. The method of claim 5, wherein the mobile device is a mobile phone.

8. A method for selecting a base station with a mobile device, comprising the steps of:
(a) determining if the mobile device comprises a base station list, if yes, executing the step (c), if not, executing the step (b);
(b) searching for a plurality of available base stations and storing in a base station list;
(c) selecting a base station from the base station list; and
(d) communicating via the base station.

9. The method of claim 8, wherein the step (d) comprises:
(e) determining if re-selecting a base station is needed in a particular time interval, if yes, executing the step (c).

10. The method of claim 8, wherein the mobile device is a mobile phone.
